(19) United States
(12) Patent Application Publication
(10) Pub. No.: US 2008/0168512 A1
(43) Pub. Date: Jul. 10, 2008

(54) System and Method to Implement Interactive Video Streaming

(76) Inventor: Thuyen X. Nguyen, Temple City, CA (US)

Correspondence Address: ORION LAW GROUP, 3 HUTTON CENTRE, SUITE 850, SANTA ANA, CA, 92707, US

(21) Appl. No.: 11/966,260

(22) Filed: Dec. 28, 2007

Related U.S. Application Data
(60) Provisional application No. 60/883,512, filed on Jan. 4, 2007.

(51) Int. Cl. H04N 7/173

(52) U.S. Cl. 725/105

(57) ABSTRACT

The invention relates generally to a system and method to implement interactive video streaming with embedded advertisements. The system includes a video server operatively coupled to a video client via a network. The video server processes an original video frame with an object-of-interest and one or more background objects, creates a first composite video frame with the object-of-interest in high video quality and with a background in low video quality to conserve space, and sends the first composite video frame to the video client. In one embodiment, the background includes all pixels that are not part of the object-of-interest.

### CROSS-REFERENCE TO RELATED APPLICATIONS

The present application for patent claims the benefit of U.S. Provisional Application Ser. No. 60/883,512, filed on Jan. 4, 2007, entitled “INTERACTIVE VIDEO STREAMING SYSTEM USING PRIORITIZED DATA REDUCTION AND EMBEDDED ADVERTISEMENTS”, by Thuyen Xuan Nguyen.

### FIELD

The invention relates generally to a system and method to implement interactive video streaming.

### BACKGROUND

In the field of video streaming, a significant source of revenue is billable advertisements. Currently advertising or commercial spots include discrete video clips interleaved in time with programming content that are sold to the advertisers and subsequently shown during the program broadcast.

It is therefore desirable to provide techniques to embed advertisements into programming content so that the advertisements cannot be skipped while viewing the programming content. It is also desirable to provide a technique to embed advertisements into programming content such that important objects in the programming content can be displayed unblocked and in full view simultaneously with the advertisements.

### SUMMARY

The invention relates generally to a system and method to implement interactive video streaming with embedded advertisements. The system includes a video server operatively coupled to a video client via a network. The video server processes an original video frame with an object-of-interest and one or more background objects, creates a first composite video frame with the object-of-interest in high video quality and with a background in low video quality to conserve space, and sends the first composite video frame to the video client. In one embodiment, the background includes all pixels that are not part of the object-of-interest.

Other aspects, advantages and novel features of the present disclosure will become apparent from the following detailed description of the disclosure when considered in conjunction with the accompanying drawings.

### BRIEF DESCRIPTION OF THE DRAWINGS

FIG. 1 is a simplified functional block diagram of an overview of a system to implement interactive video streaming with embedded advertisements in accordance with one exemplary embodiment of the invention;

FIG. 2 is a simplified block diagram of the Video Server in accordance with one exemplary embodiment of the invention;

FIG. 3 is a block diagram of the Video Client in accordance with one embodiment of the invention;

FIG. 4 is a block diagram illustrating a typical Ad Server 32 that works in conjunction with other components of the system in accordance with one embodiment of the invention;

FIGS. 5A, 5B, 5C, 6, and 7 illustrate sample video frames at various stages of processing in accordance with one embodiment of the invention.

### DETAILED DESCRIPTION

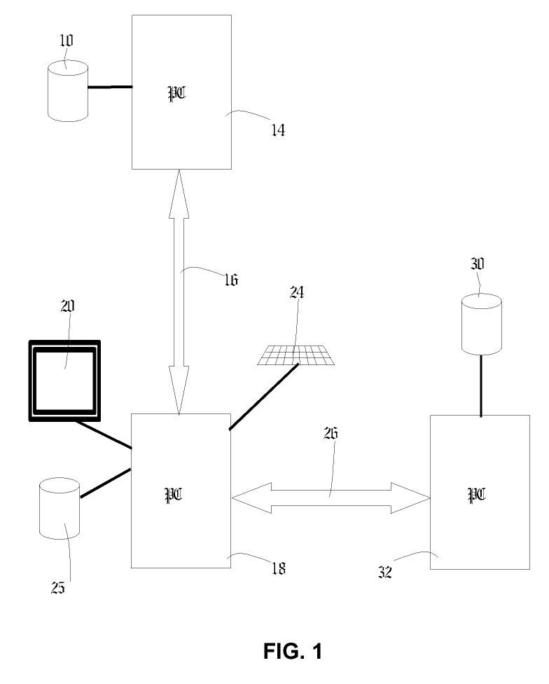

FIG. 1 is a simplified functional block diagram of an overview of a system to implement interactive video streaming with embedded advertisements in accordance with one exemplary embodiment of the invention. FIG. 1 shows three main components of the system, including the Video Server 14, the Ad Server 32, and the Video Client 18. In one embodiment, the Video Server 14 acquires the video data from a storage unit 10, and communicates with the Video Client 18 via a network connection 16.

The Video Client 18 stores the advertisements received from the Ad Server 32 in its storage unit 25, and displays the merged content of the advertisements and the incoming video stream on the display unit 20 to the viewer. In addition, the Video Client 18 accepts input parameters, via the input device 24, from the viewer and sends these parameters to the Video Server 14 when applicable. In one embodiment, exemplary input parameters accepted by the Video Client could include selection or de-selection of the object-of-interest, ratio of video quality of the object-of-interest and the background, and/or video parameters (e.g., brightness) of objects in the video frame.

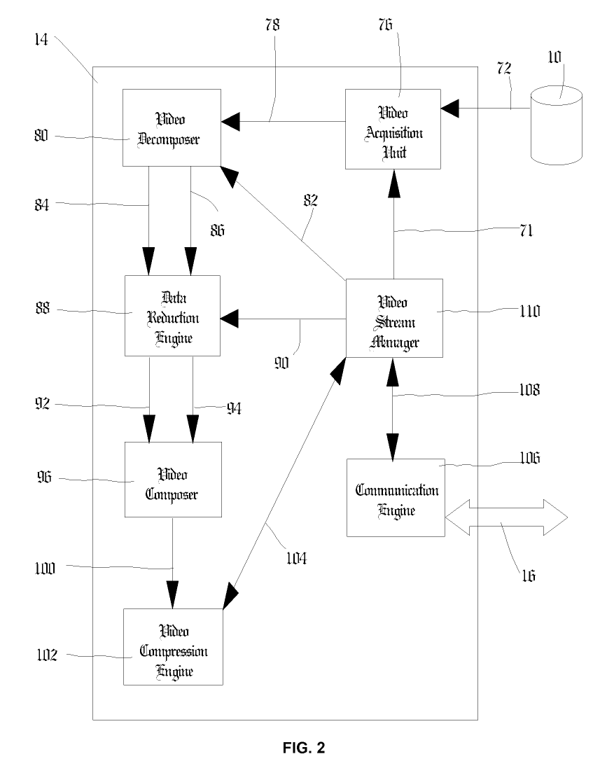

FIG. 2 is a simplified block diagram of the Video Server 14 in accordance with one exemplary embodiment of the invention. This figure also illustrates exemplary activities that the Video Server 14 undertakes to process the video data potentially extracted from the storage unit 10 coupled to the Server 14. As shown in FIG. 2, the Video Server 14 includes a Communication Engine 106 that is generally responsible for receiving and sending messages and/or data between the Video Server 14 and the Video Client 18 using a standardized wired or wireless network communication protocol. In one embodiment, the Communication Engine 106 also monitors network traffic and statistics.

The Video Server 14 also includes a Video Stream Manager 110 and a Video Acquisition Unit 76. In general, the Video Stream Manager 110 manages the video stream. When the Video Stream Manager 110 receives a request to start a video streaming process 108, the Manager 110 sends a command to the Video Acquisition Unit 76 to initiate the processing of the video stream. The Video Acquisition Unit 76 then proceeds to retrieve original compressed video frames 72 from the storage unit 10. In one embodiment, the Video Acquisition Unit 76 generates intermediate video frames 78 by converting each retrieved original video frame 72 into an uncompressed format, and by replacing each pixel of the original video frame in the keyed color with a pixel in another predetermined color. In one embodiment, the keyed color would be green. However, other keyed colors such as blue, red, or magenta could be adopted.

The keyed color is used as the alpha or transparency channel for later merging of the video frames. In digital composition, the principal subject is filmed or photographed against a background consisting of a single color or a relatively narrow range of colors, usually blue or green because these colors are considered to be the furthest away from skin tone. Blue is generally used for both weather maps and special effects because it is complementary to human tone. However, in many instances, green has become the favored color because digital cameras retain more detail in the green channel and it requires less light than blue. Green not only has a higher luminance value than blue but also in early digital formats the green channel was sampled twice as often as the blue, making it easier to work with. In general, the choice of color is up to the effects artists and the needs of the specific shot. Although green and blue are the most common background colors, any color could be used. As an example, red is usually avoided due to its prevalence in normal human skin pigments, but can be often used for objects and scenes which do not involve people. As another example, a magenta background could be used occasionally.

As the Video Acquisition Unit 76 completes the generation of an uncompressed intermediate video frame 78, the Unit 76 sends the frame 78 to the Video Decomposer 80. A function of the Video Decomposer 80 is to separate an object-of-interest from the background of the video frame based on the viewer's selection and/or specification of the object-of-interest.

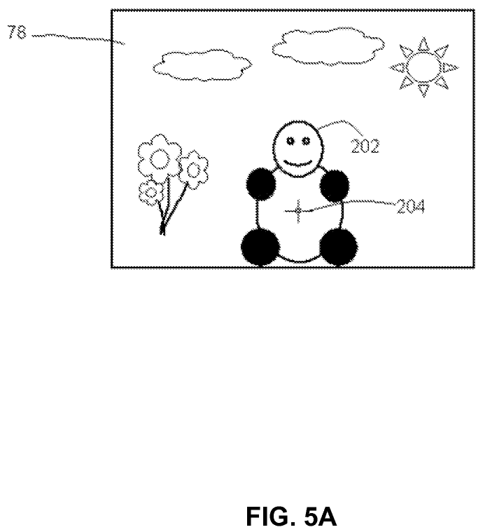

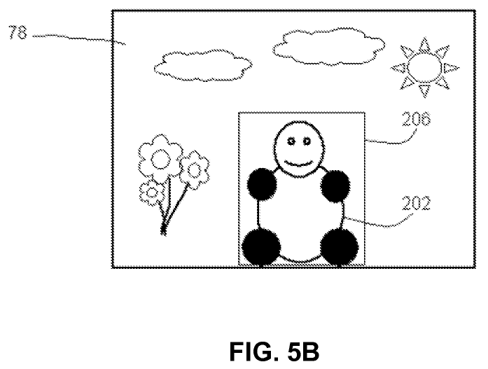

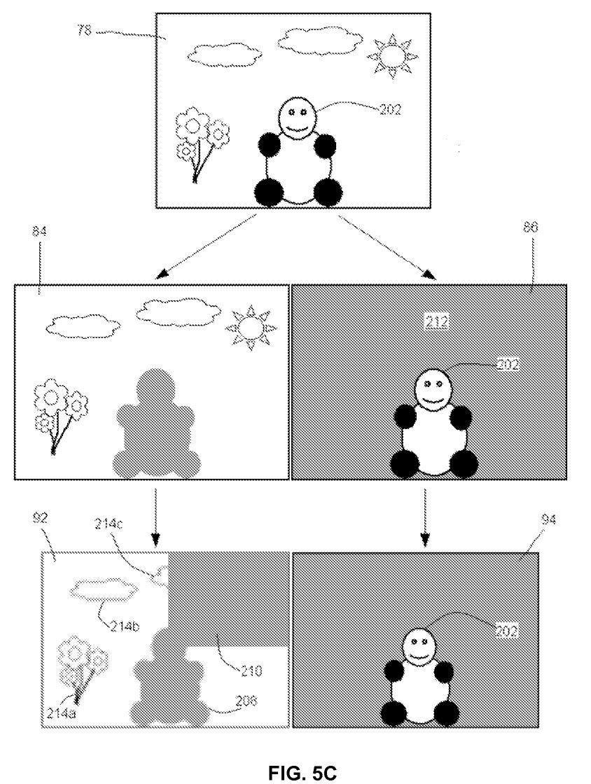

Turning now to FIGS. 5A and 5B, these figures illustrate the viewer's selection of the object-of-interest. In one embodiment, as shown in FIGS. 5A and 5B, the viewer could select the object-of-interest 202 by placing the cursor 204 on the object-of-interest 202 (shown in FIG. 5A) or by selecting a region-of-interest 206 in which the object-of-interest 202 is located (as shown in FIG. 5B). Furthermore, although the region-of-interest 206 is shown in FIG. 5B as a rectangle, the region-of-interest 206 could be implemented as any geometric shape (such as a circle or an oval shape).

Turning back to FIG. 2, to determine the viewer's selection or specification of the object-of-interest (shown as 202 in FIGS. 5A and 5B), the Video Decomposer 80 queries the Video Stream Manager 110. If Video Stream Manager 110 returns the position on the object-of-interest, the Video Decomposer 80 uses the position to identify the object-of-interest and the background in the uncompressed intermediate video frame 78. Then the Video Decomposer 80 creates a background video frame 84, which is essentially the content of original video frame 78 with the object-of-interest being replaced by the keyed color. An object-of-interest-only video frame 86 is also created, with the keyed color as its background. In one embodiment, if the position on the object-of-interest is not known, or an object-of-interest cannot be identified at the selected position, then this object-of-interest-only video frame 86 would be empty. In this scenario, the Video Server 14 would act as though the object-of-interest has not been selected. As a result, the Video Server 14 would retain the entire background.

Both the background video frame 84 and the object-of-interest-only video frame 86 are then sent to Data Reduction Engine 88. In one embodiment, the Engine 88 acquires certain parameters (such as available bandwidth between the Video Client 18 and the Video Server 14, or the ratio of video quality of the background and the object-of-interest) from the Video Stream Manager 110, which in turn queries the Communication Engine 106 to retrieve such network parameters. Based on the parameters that it receives, the Data Reduction Engine 88 modifies the size of the background video frame 84. For example, if the available bandwidth between the Video Client 18 and the Video Server 14 is relatively low, the Data Reduction Engine would perform a frame data reduction process to decrease the size of the background video frame 84 by reducing, for example, the spatial and/or color resolutions of the frame 84. Other examples of frame data reduction algorithms or techniques would include removing and smoothing out of details of objects, blurring the objects, reducing contrasts of objects, removing noise, and modifying the frame rates of objects.

In one embodiment, during the frame data reduction process, one or more quadrants of the background video frame 84 would be filled with the keyed color, or maybe even the entire background is removed. At the same time, the object-of-interest-only video frame 86 may undergo through a less aggressive data reduction process or none at all, depending on the network parameters 90. Upon the completion of the frame data reduction process, the reduced background video frame 92 and the reduced object-of-interest-only video frame 94 are then passed to the Video Composer 96. The Composer 96 uses the keyed color green to correctly merge the two frames 92 and 94 into a single composite video frame 100, containing a higher quality object-of-interest and a lower quality background.

The composite video frame 100 is passed to the Video Compression Engine 102, which also retrieves its compression parameters 104 from the Video Stream Manager 110. The Video Compression Engine 102 can use any appropriate video compression technology such as uniform compression (lossy or lossless). Other examples of video compression technologies include H.264, DIVX, MPEG, WMV, or any other compression technologies that could be adopted for use in video streaming. The composite video frame 100 is then compressed and passed to the Video Stream Manager 110, to be sent out by the Communication Engine 106.

In one embodiment, if the viewer has not selected an object-of-interest, the object-of-interest-only video frame 86 would be empty. Furthermore, if the viewer has not selected an object-of-interest, the Data Reduction Engine 88 would only reduce data from the background video frame 84, but would not replace any part with the keyed color green, so that the viewer can see the complete video frame from which to select the object-of-interest.

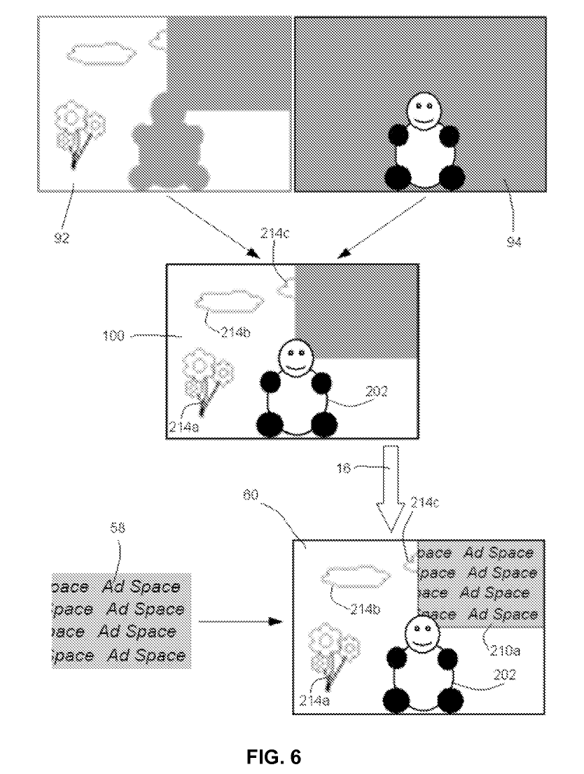

Turning now to FIG. 5C and FIG. 6, these figures contain sample video frames at various stages of processing in accordance with one embodiment of the invention. The selected object-of-interest 202 is the “bear” in the center of the video frame. The reference numbers on each sample video frame corresponds to the reference numbers on the activity diagrams.

As shown in FIG. 5C, frame 78 is a sample intermediate video frame 78 generated by converting a corresponding original video frame 72 (shown in FIG. 2) into an uncompressed format, and by replacing each pixel of the original video frame 72 in the keyed color with a pixel in another predetermined color. In addition, video frame 84 is an exemplary background video frame generated from the intermediate video frame 78. Furthermore, the background video frame 84 includes essentially the content of intermediate video frame 78 with the object-of-interest 208 being replaced by the keyed color. Video frame 92 is an exemplary reduced background video frame generated from the background video frame 84. As shown in FIG. 5C, the reduced background video frame 92 is generated by filling a quadrant 210 of the frame 92 with the keyed color. Furthermore, the resolution of background objects 214a, 214b, and 214c in the frame 92 have been reduced to further decrease the size of the frame 92, and then enlarged to the appropriate size to enable higher compression.

FIG. 5C also includes video frames 86 and 94. Video frame 86 is a sample object-of-interest-only frame generated from the uncompressed intermediate video frame by retaining the object-of-interest 202 while filling the background with the keyed color. Video frame 94 is an exemplary reduced object-of-interest-only video frame generated from the object-of-interest-only video frame 86. In the example shown in FIG. 5C, except for a slight reduction in size, no other data reduction was applied to the content of the frame 94 to maintain high video quality.

FIG. 6 shows the reduced background video frame 92 and the reduced object-of-interest-only video frame 94 being merged into a single composite video frame 100 with a higher quality object-of-interest 202 and lower quality background, including lower quality background objects 214a, 214b, and 214c.

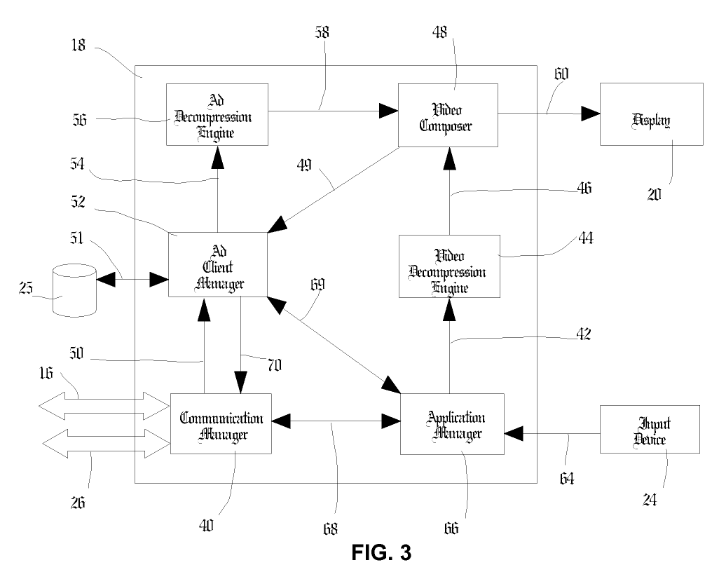

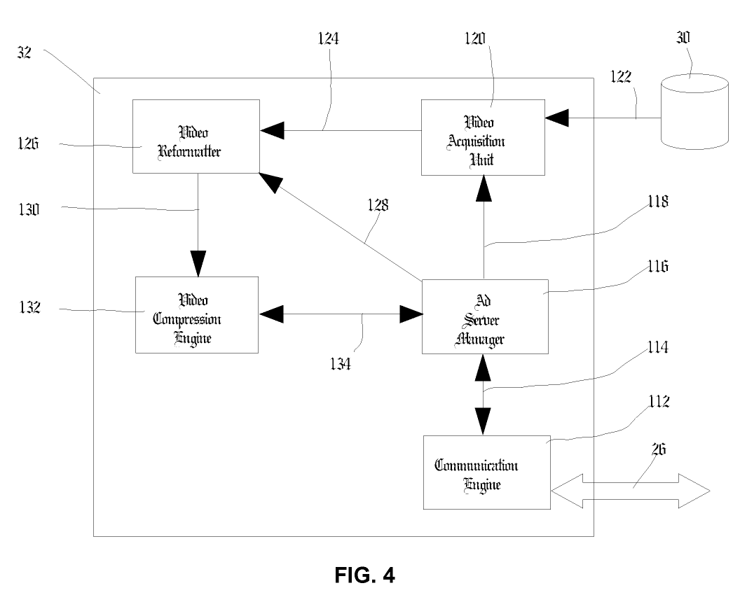

Turning now to FIG. 3, this figure is a block diagram of the Video Client 18, and generally illustrates activities of the Video Client 18 in accordance with one embodiment of the invention. Among other functionalities, the Video Client 18 is generally responsible for accepting the viewer's input, for merging the advertisements into the video stream, and for displaying the merged video stream. The Video Client 18 has a Communication Manager 40 that sends and receives messages from the Ad Client Manager 52 and the Application Manager 66 via the network connections 26 and 15. The Ad Client Manager 52 is generally responsible for sending requests for advertisements 70 to the Ad Server 32 (shown in FIG. 4), and for storing the received advertisements 50 to the storage unit 25.

The Application Manager 66 initially sends a request for the main video stream to the Video Server 14, and processes the incoming video stream 68. It also sends viewer input parameters from the input device 24 to the Video Server, when applicable. As stated above, in one embodiment, the viewer input parameters could include selection or de-selection of the object-of-interest, ratio of video quality of the object-of-interest and the background, and/or video parameters (e.g., brightness) of objects in the video frame. When the Application Manager 66 receives a compressed video frame from the incoming video stream 68, it sends the compressed video frame 42 to the Video Decompression Engine 44, which creates an uncompressed video frame 46 and sends it to the Video Composer 48. The Composer 48 examines the uncompressed video frame 46 and uses the selected keyed color to correctly merge advertisements with the uncompressed video frame 46 into a single merged composite video frame 60, containing a high video quality object-of-interest, high video quality advertisements, and lower quality background (if any).

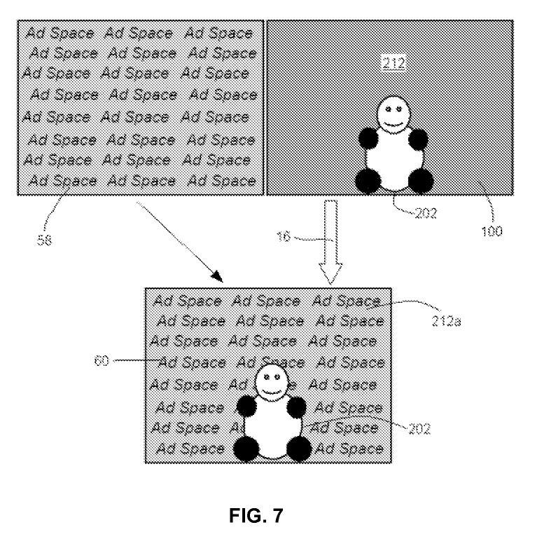

As shown in FIG. 6, the merged composite video frame 60 includes the content (including the object-of-interest 202 and the background including background objects 214a, 214b, and 214c) of the video frame 100 merged with advertisement 58, with the advertisement 58 being placed in a selected quadrant 210a. Alternatively, as shown in FIG. 7, the background frame 92 (shown in FIG. 5C and FIG. 6) could be entirely removed from processing. In this scenario, the video frame 100 would only contain the object-of-interest 202 against a background in the keyed color. This video frame 100 would be merged with the advertisements 58, resulting in the merged composite frame 60 with the object-of-interest 202 against a background 212a covered by advertisements.

Turning back to FIG. 3, the merged composite video frame 60 is sent to the display unit 20 to be displayed to the viewer. In one embodiment, the advertisements can be video frames from a video advertisement, or just still images, in which case, the Ad Client Manager 52 would supply the same images repeatedly.

Once the merged composite video frame 60 is displayed, the viewer could select one or more advertisements in the frame 60. In one embodiment, the viewer could use the input device 24 to point to and select the advertisement, thereby generating a selected advertisement position 64 and sending the position 64 to the Application Manager 66 in the Video Client 18. When the Application Manager 66 receives the selected position 64 from the input device 24, it sends the selected position 69 to the Ad Client Manager 52, which uses the information 49 supplied by the Video Composer 48 previously to determine which advertisement was selected, if any. If an advertisement was selected, the Ad Client Manager 52 will carry out the instructions supplied with that ad, such as a pop-up web browser displaying the ad client's homepage, and sending a click-count message 70 to the Ad Server 32, etc. In one embodiment, the selected ad could be brought in front of objects in the video frame (i.e., overlaying on top of objects in the video frame), or push to the back of the objects (i.e., underlaying the objects).

If the selected position 69 does not correspond to any ad, the Ad Client Manager 52 sends a notification 69 to the Application Manager 66, which then sends the selected position 68 to the Video Server 14 (via the Communication Manager 40) indicating the viewer has selected a new position from which to determine the object-of-interest.

In one embodiment, to view the whole video without advertisements, the Application Manager 66 provides a mechanism, such as a button on the user interface, to void the selection of the object-of-interest, which results in an empty position being sent to the Video Server 14. This mechanism provides a way for the viewer to select a new object-of-interest that was hidden by the advertisements previously.

FIG. 4 is a block diagram illustrating a typical Ad Server 32 that works in conjunction with other components in accordance with one embodiment of the invention. The Ad Server 32 is available in the marketplace, and is typically adopted by Google or Yahoo in their respective networks to facilitate the displaying of advertisements on their respective web pages. The Ad Server 32 is included here for completeness. Because the advertisements are not being streamed in real-time, they can be sent in high quality yet using low bandwidth, at the expense of time.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein. Exemplary possible additions to the inventive interactive video streaming system would include:

Instead of retrieving video from a storage unit 10, the Video Server 14 gets it directly from a video camera. The Video Acquisition Unit 76 and/or the Video Decomposer 80 are modified to identify the object-of-interest at the selected position in real time. LIDAR (Light Detection and Ranging) video camera systems, which use light waves to detect pixel depth, would be useful in this process. Depth perception can also be done by processing videos from multiple cameras. Motion tracking is another viable method.

Video conference or video chat system: instead of using the disclosed one-way video streaming, an alternative system can be implemented to do two-way video streaming, by adding another copy of the disclosed system in the reverse direction, and using video cameras as sources. Viewers at both ends see different advertisements in the background. Similarly, the system can be expanded further to support multi-way video conferencing.

Allowing selection of multiple objects-of-interest

Adding capability to select a region of interest (rectangular or circular)

Allowing viewer to turn on audio in advertisements, if audio is available

Defining and using different advertisement positions and sizes

Using Ad Servers from companies other than Google or Yahoo

Implementing the inventive system in web camera (webcam) games for PC and game consoles, where the Video Client and the Video Server runs on the same platform, with advertisements from the Ad Server in the background. Webcam games are games that capture the player's image and display it on the screen.

Implementing moving ads and/or streaming ads.

What is claimed is:

1. A system to process video streams, comprising:
a video server operatively coupled to a video client via a network;
the video server processes an original video frame with an object-of-interest and one or more background objects, creates a first composite video frame with the object-of-interest in high video quality and with a background in low video quality to conserve space, and sends the first composite video frame to the video client.

2. The system of claim 1, the video client receives an object-of-interest selection.

3. The system of claim 1, wherein the video server determines the object-of-interest selection based on a cursor position.

4. The system of claim 1, wherein the video server determines the object-of-interest selection based on a selected region-of-interest.

5. The system of claim 1, wherein the background of the first composite video includes pixels that are not part of the object-of-interest.

6. The system of claim 1, wherein the background of the first composite video includes one or more background objects.

7. The system of claim 1, wherein the video server replaces one or more quadrants of the background with a keyed color to conserve space.

8. The system of claim 1, wherein the background of the first composite video is generated using one or more data reduction techniques while the object-of-interest is maintained in its original video quality.

9. The system of claim 1, wherein the video client receives the first composite video frame, creates a second composite video frame by merging one or more advertisements onto the background of the first composite video frame while retaining the object-of-interest, and displays the second composite video frame on a display unit,

10. The system of claim 9, wherein the video client monitors for viewer input to determine whether an advertisement has been selected.

11. The system of claim 10, wherein the video client toggles the display of a selected advertisement in front of objects in the video frame or to the back of objects in the video frame based on the viewer input.

12. A method to process video streams, comprising:
processing an original video frame with an object-of-interest and one or more background objects, creates a first composite video frame with the object-of-interest in high video quality and with a background in low video quality to conserve space.

13. The method of claim 12, wherein the background of the first composite video includes one or more background objects.

14. The method of claim 12, further comprises generating the background of the first composite video frame using one or more data reduction techniques while maintaining the object-of-interest in its original video quality.

15. The method of claim 12, further comprises determining a selection of the object-of-interest selection based on a cursor position.

16. The method of claim 12, further comprises determining a selection of the object-of-interest based on a selected region-of-interest.

17. The method of claim 12, further comprises replacing one or more quadrants of the background with a keyed color to conserve space.

18. The method of claim 1, further comprises creating a second composite video frame by merging one or more advertisements onto the background of the first composite video frame while retaining the object-of-interest.

19. The method of claim 18, further comprises merging one or more advertisements onto one or more quadrants of the background.

20. A computer readable medium to process video streams, the computer readable medium comprising codes to cause at least one computing device to:
process an original video frame with an object-of-interest and one or more background objects, creates a first composite video frame with the object-of-interest in high video quality and with a background in low video quality to conserve space.
